(19) United States
(12) Patent Application Publication
(10) Pub. No.: US 2007/0289503 A1
(43) Pub. Date: Dec. 20, 2007

(54) Process turning fly ash into useful building blocks and the like

(76) Inventors: Hendrik Loggers, Amerongen (NL); Gijsbert Versteeg, Nunspeet (NL)

Correspondence Address: HENDRIK LOGGERS, PRINSES BEATRIXLAAN 19, AMERONGEN, 3958XJ, omitted

(21) Appl. No.: 11/455,802

(22) Filed: Jun. 20, 2006

(51) Int. Cl. C04B 18/06

(52) U.S. Cl. 106/710; 106/705

(57) ABSTRACT

Method to manufacture useful building bricks, blocks and elements by pressing granulated or partly granulated material comprising fly ash that may vary in quantity up to 92% of by weight, and cement. The average apparent density of the building materials may vary from aerated concrete density, which is 0.8 to 1.52 gram per cubic centimetre. The granulated or partly granulated mixture is formed to brick, block or element in a press, characterizing the process, suitable to compact the material under specific pressures varying up to 35 Newton per square millimetre of mixture mass. The press is of the type known as Sand Lime Brick press. The moisture content of to compress and to form mass may not exceed 13%, to enable the automatically working clamp of the press to take off rows of building blocks and the like and to place the rows on top of each other on a hardening car. Hardening of the products takes place under known cement hardening conditions. Granulating the raw materials is preferably done by a rotating apparatus and is characterized by the forming of a very wet core that is being surrounded by relative dry mixture. The building material is meant to be used in dry staying inner wall constructions and can be of the load bearing type. (U.S class S) Compressive strength of 15 N/mm are attained with 12% cement in the mixture. In case of high Sulphur content in the ash, a special ash treatment is foreseen to avoid ettringite forming that can destroy the building material by expansion. Sand ime Brick presses having an enormous capacity, may work to 20 metric tons of fly ash per hour.

### FOREIGN APPLICATION PRIORITY DATA

| | |
|---|---|
| Aug. 11, 2005 | The Netherlands(LOGGERS/VERSTEEG) |
| No. 1029718 | |
| Int. CI: 8 | CO4B 18/02 CO4B40/00 CO4B18/08 BO1J2/22 |
| Field of Search | CO4 B01J |

### REFERENCES CITED

| | |
|---|---|
| FR 1 427 482, (E. KRANZ) | 1966-02-04 |
| DE 1 961 0561 (MOEDINGER, HILDEGARD) | 1997-09-25 |
| JP 2 001 278 647 (TAKENA KOMUTEN KK) | 2001-10-10 |
| GB 1 564 600, (WEXHAM DEVELPOMENTS LTD) | 1997-09-25 |

### BACKGROUND OF THE INVENTION

1. Field of the Invention

The present invention relates to a process of forming building bricks, block and elements comprising at least ash, particularly fly ash from coal-fired units such as combustors of coal fired power plants and fluidized bed combustors and ash from garbage incinerators, and a binder, such as lime, anhydrite or cement. The preferable binder is cement. Products are formed by pressing granulated mixture or a mass of granulated mixture and non granulated material. The moisture content of the mass is restricted to maximal 13%. The press may apply specific pressures varying from 10 to 35 N/mm2 on the mixture mass.

2. Brief Summary of the Invention

Object of the invention is to provide building material in brick, block or element, which have sizes up to 35×60×90 centimetres, of mixtures comprising at least ash, particularly fly ash from coal-fired units such as combustors of coal fired power plants and fluidized bed combustors and ash from garbage incinerators, and a binder preferable cement. The products are hardened under known cement hardening conditions. Forming the building material is accomplished by a press that can compress the material at pressures up to 35 Newton per square millimetre. The material to be formed is a mixture that may contain up to 92 percent ash by weight next cement as binder. To be able to fill the moulds present in the press correctly the raw material mixture is granulated before filling the moulds. The moisture content of the pellets may not exceed 13%. Another method to fill the moulds is using pellets, in plastic state or hardened, in combination with a mixture of ash, water and cement. In case the pellets are deformable the moisture content of the mixture must not raise the average moisture above 13%.

The press forms products in a row, which are taken off and placed automatically on top of another row on a car for shipping to the hardening area of the factory. In one pressing, the cycle of the press, several bricks, blocks or elements are produced in a row. Devices may be present in the moulds to form cavities in the green brick, block or element. Depending on the total cavity volume the apparent density of products varies from 0.8 (density of aerated concrete) to about 1.52 g/cm3.

Coal ash comprising building material is known. In Germany mixtures of about 30% fly ash and 63% sintered bottom ash, providing the necessary coarser material, and 7% lime are used to manufacture blocks that have to be hardened in an autoclave. In China bricks are manufactured, not higher than 5 centimetres, having 25% cavity volume, by compressing a mixture containing about 50% fly ash and 50% sand-lime mixture. The bricks are hardened under hydro-thermal condition in an autoclave. An American publication reveals the forming and compacting of elements by vibration, comprising fly ash and a high percentage of bottom ash and cement.

In the British patent 1564600 the production of building blocks in a vibrating mould charged with ash containing pellets is described. The pressure on the mass is performed by a 15% surcharged of pellets volume. The building blocks without cavities have bulk densities of less than 1200 kg/m3, which is below the apparent densities of blocks without cavities manufactured by applying specific pressures varying from 10 to 35 N/mm2 using the method of the invention. Secondly the moisture content of the pellets by the British patent is 18% as mentioned in the example, which exceeds far the moisture content of the material used by the method of the invention, which is maximal 13%. Third difference is that the time of forming a block is 30 seconds. Forming building materials by applying high specific pressures on the material in the moulds of the press takes less than 30 seconds per stroke.

In the French patent, 1 427 482, the aim is a very light weight building material to produce from wet pellets surrounded by dry mixture of ash and lime. Densification also takes place by vibration while applying a very low pressure on top of the mass in the mould, like in the British patent. As binder lime is used, while cement is used to surround the wet pellets. Nor the British or the French patent reveals the presence of holes in the block formed.

### DETAILED DESCRIPTION OF THE INVENTION

The present invention makes it possible to press building bricks, blocks and elements in moulds having filling heights of 1.6 times the height of the product by using granulated mixtures of high percentages ash, that may be as high as 92%. The building materials are pressed and shaped by a press of a type in use in Europe to manufacture Sand Lime Bricks. Producers of the presses are for instance Dorstener Maschinenfabrik Ag and Lasco Umformtechnik GmbH. The press can provide specific pressures on the material in the moulds in line up to about 35 Newton per square millimetre. Compacting and forming the ash containing material to useful building brick, block or element can already be done by applying a pressure of 10 N/mm2, but higher pressures bring higher densities, higher mechanical strengths and smoother block surfaces. The fly ash content of the building material may vary to 92% by weight, by using the preferable binder cement, but in case ash from a circulating fluid bed boiler is used, binder may not be required. Compressive strength of the hardened building block of 15 N/mm can be attained with mixture containing 12% cement, Portland or slack cement. As the water absorption is too high products are in principle meant for inner wall constructions. Moulds can be provided with devices to form cavities in the building material during pressing. By changing the total volume of the cavity making tools in the moulds, the average apparent density of the blocks can be varied from 0.8 (aerated concrete density) to 1.52 gram per cubic centimetre. The moisture of the mass to be shaped in the press may not exceed 13%. In case the moisture content is exceeding, slurry may be pressed out of the moulds, while the height measure of the shaped material, coming out of the press moulds, may vary and taking off by the automatically working clamp device of the press will become problematic. In case moisturized powdery mixer is fed to the moulds air present in the material can not escape sufficiently during compressing, so that during pressure release the mass will expand. This situation can by bettered by raising the moisture, but then in the most favourable case, a product is formed low in apparent density and showing layers and cracks. Correct production is possible by applying mass in granulated form. Granulated press feed can be produced by extrusion or by rotating the raw material in a drum or on a disk.

The 13% press-humidity can be achieved by surrounding pellets, containing 24% moisture on dry, by a drier raw material mixture. The other way to adjust moisture is mixing the wet pellet with a dry mixture of material before charging the moulds in the press. To manufacture pellets in a rotating apparatus the moisture content of, for instance a mixture having 8% moisture, have to be raised at least to 22% to form pellets. To bring the pellets for instance at 13% moisture level, 31 percent of the 24% granulated material, calculated as dry, must be surrounded by 69% mixture of 8%. The other possibility is that a mixture suitable to press is formed of 31% pellets of 24% moisture and 69% mixture having 8% moisture. If hardened granulate is used, a higher quantity of pellet can be mixed with ash, water and cement mixture.

In case the press would accept only material with lower average moisture, for instance 10%, the dry material may have for instance 2%. The quantity of pellets, base on dry weight, is now 36%. The dry mixture can partly be used to surround the 24% pellets and partly be mixed with the surrounded pellets. So there are many different ways that lead to usable press moisture. In case ash contains a too high an amount of Sulphur compound a special treatment of the ash by a raised temperature with lime is necessary to avoid that masonry products are being destroyed by expanding of formed ettringite. The time a production cycle is performed by the high pressure press takes about 6 to 25 seconds, depending on the format of the building material and the press capacity. The advantage of using granulate or a mixture of granulate and non granulated material, having restricted moisture content, is that not only brick or block sized building material can be produced, but also larger sized building materials containing high percentages of ash, having sufficient strength to be taken off in rows by an automatically working press clamp device for placing the building products on a car. This is achieved by the high specific pressure on the material in the moulds and by the restricted water content of the material, which is lower than mentioned in the French, 1 427 482, and the British, 1 564600, patent.

The press produces several bricks, blocks or elements in row in one cycle, which row can be placed on top of each other on a car by the automatically working device. Products made by vibration are usually manufactured by concrete presses in rows on a board, on which the building blocks stay for a while to build up sufficient strength for take off and further handling. By granulation the mass volume of the raw material mixture, ash, cement and water, is changed from about 0.65 to 1. The mixture has been pre-compacted by granulation and the second advantage is that even over great filling heights moulds can be filled properly. During the forming under pressure the remaining air present in the voids between the compressible nodules escapes, while the wanted shape of the building material is properly formed. In case the moisture content of the nodules is still too high, a dry mixture of ash and binder can be added. After shaping the building material, the product is pressed out of the mould and taken out of the press by an automatically working clamp and placed on a car to transport the building material to the hardening area of the factory, where the product after a certain time of hardening can be taken off the hardening car to be stacked in store for further hardening.

It is possible to work up 22 metric tons of fly ash per hour by the method of present invention by two presses working in two shifts. So the ash of a Power plant of 500 mega Watt, producing 100000 metric tons fly ash per year, can get rid of the ash if a block factory is connected to the plant.

We claim:

1. Process of forming building bricks, blocks and elements, characterized by pressing granulated mixture at least comprising fly ash, particularly fly ash from coal-fired units such as combustors of coal fired power plants, and cement, which granulate is formed by surrounding wet nodules, having about 22% moisture, with relative dry mixture, resulting in a moisture content of maximal 13%, in a press, able to perform specific pressures varying up to 35 Newton a square millimetre on the ash containing mass.

2. Process according to claim 1, characterized by applying a Sand Lime Brick press.

3. Process according claim 1 or 2, wherein the, to compact and to form, material consists of a mixture of granulated and non-granulated material.

4. Process by any preceding claim manufacturing building brick, blocks and elements with average apparent densities varying from 0.8 to 1.52 gram per cubic centimetre by using special moulds in the press.
